(19) United States
(12) Patent Application Publication
(10) Pub. No.: US 2007/0276811 A1
(43) Pub. Date: Nov. 29, 2007

(54) Graphical User Interface for Displaying and Organizing Search Results

(76) Inventor: Joshua Rosen, Bolinas, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/752,279

(22) Filed: May 22, 2007

Related U.S. Application Data
(60) Provisional application No. 60/747,994, filed on May 23, 2006.

(51) Int. Cl. G06F 17/30; G06F 7/00

(52) U.S. Cl. 707/3

(57) ABSTRACT

A search engine graphical user interface (GUI) displays a search result, which may contain a single page or multiple pages, in an independently updatable section, such as an inline frame. With this implementation, a user can update the display contents of a search result, e.g., by navigating to a different page of a multi-page search result, without disrupting the rest of the web page, and a user can create or add to a search listing collection by grabbing a search result using an input device and dropping it into a virtual basket for collecting and organizing search results.

### CROSS-REFERENCE TO RELATED APPLICATIONS

This application claims the benefit of U.S. Provisional Patent Application Ser. No. 60/747,994, filed May 23, 2006, the entire contents of which are incorporated by reference herein.

### BACKGROUND OF THE INVENTION

1. Field of the Invention

The present invention relates generally to search engine graphical user interfaces (GUIs) and, more particularly, to search engine GUIs for displaying and organizing search results.

2. Description of the Related Art

Search engines have become popular tools to identify and locate specific information on the Internet. A search engine is a computer program that, when queried for information, retrieves either related information or pointers to the location of related information, or both, by evaluating content stored in its search database.

The search engines provided by Yahoo!, Google and MSN accept a search query and returns search results ranked in accordance with their respective relevance algorithm. These search results are displayed through a GUI that includes an editable text field that displays the search query, a listing of search results, and a listing of text advertisements known in the art as sponsored links. A click on any of the search results hyperlinks the user to the web site associated with that search result and a click on any of the sponsored links hyperlinks the user to the web site of the sponsor.

The GUIs for displaying search results have remained fairly simple. There are some exceptions, one of which is the GUI provided by the A9 search engine. This GUI allows the user to configure the display layout of the search results. One or more types of search results can be configured to be displayed to the user in separate columns. The types of search results include: Web, Yellow Pages, People, Books, Reference, Blog Search, News, Movies, Wikipedia, and More Choices.

A major motivation for keeping GUIs for displaying search results simple is to keep them user-friendly. The goal of search engines is increased usage and the common wisdom is that a simpler interface broadens the base of potential users. As a consequence, the GUIs for displaying search results, in general, have been limited in providing other functionalities, such as tools for organizing search results. To organize search results, users, for the most part, have employed bookmarks. This can be done, for example, by a right-click on the mouse followed by the selection of the option “Add to Favorites.” Recently, tags have been used increasingly as a tool for organizing a series of hyperlinks under a tag name defined by the user. A major advantage of tags over bookmarks is that tags can be shared with other users.

### SUMMARY OF THE INVENTION

The present invention provides an improved search engine GUI for displaying and organizing search results, a method for generating the GUI and a method for organizing search results using the GUI. The GUI according to the present invention has remained simple and easy-to-use, and the tools for organizing search results provided by the GUI are simple, easy-to-use, and also intuitive.

The GUI according to an embodiment of the present invention includes a first section including a text input field for a search query, and a second section comprising a plurality of subsections, wherein each of the subsections displays at least one search result that is responsive to the search query in such a manner that the displayed content in each of the subsections can be updated in response to receipt of new data, independently with respect to the first section and the other subsections.

One way to implement the GUI according to an embodiment of the present invention is through inline frames. In this implementation, an inline frame is prepared for each search result, and each search result is displayed to the user within its respective inline frame. When a search result includes a collection of search listings, the pages from this collection is displayed to the user one at a time. The user can move between pages by clicking on GUI controls provided for paging backward and forward. In response to this user action, the inline frame associated with the search listing collection is updated, but the rest of the web page is not updated.

The GUI according to a further aspect of the present invention includes a third section for organizing search results into search listing collections. This third section includes a drop region. A user can begin a search listing collection or add to a search listing collection by grabbing a search result from the second section using an input device, such as a mouse, and dropping it into the drop region. The search listing collections that are generated in this manner can be shared with other users and may even appear as a search result in the second section.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a networked computer environment in which the present invention may be practiced.

FIG. 1B is a block diagram of an exemplary client computer that is part of the networked computer environment shown in FIG. 1A.

FIGS. 2A-C are schematic representations of web pages that include a GUI according to an embodiment of the present invention.

FIGS. 3A-F illustrate various processes for updating a GUI according to an embodiment of the present invention.

FIG. 4 is a flow diagram that illustrates the steps carried out by a user to organize search results using a GUI according to an embodiment of the present invention.

FIG. 5A is a flow diagram that illustrates the steps carried out by a server computer to generate a web page including search results according to an embodiment of the present invention.

FIG. 5B is a flow diagram that illustrates the steps carried out by a server computer to update a web page including search results according to an embodiment of the present invention.

FIGS. 6A and 6B are schematic representations of web pages that include a GUI according to another embodiment of the present invention.

FIG. 7 is a schematic representation of a web page that includes a GUI according to still another embodiment of the present invention.

FIG. 8 is a flow diagram that illustrates the steps carried out by a client computer in response to a user who is making inputs to a GUI that displays a search listing collection.

### DETAILED DESCRIPTION

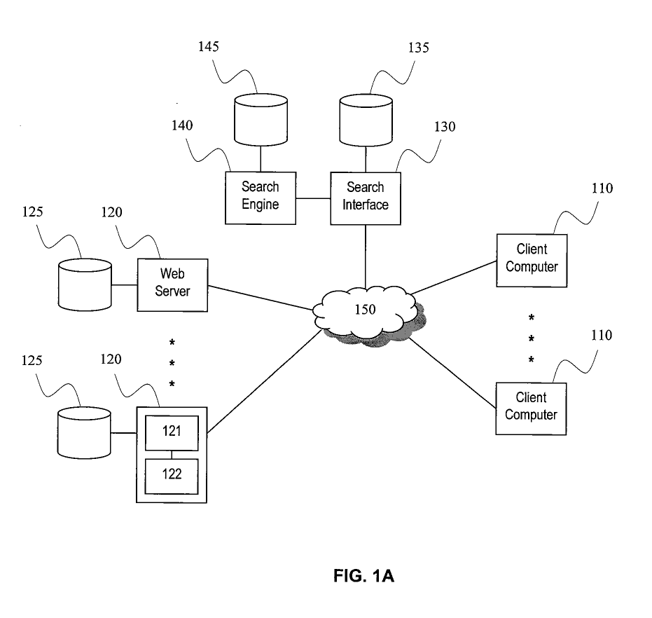

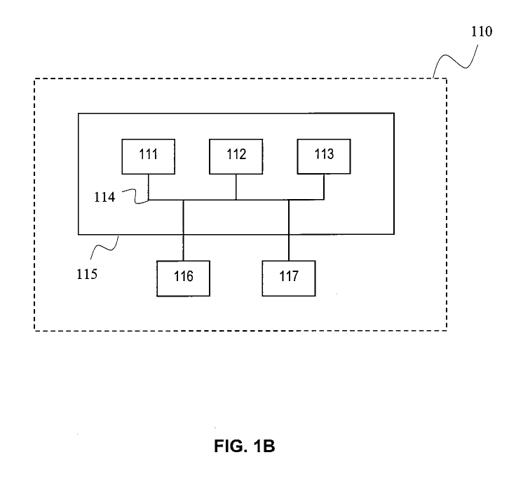

FIG. 1A illustrates a networked computer environment in which the present invention may be practiced. As shown, the networked computer environment includes a plurality of client computers 110 (only two of which are shown), a plurality of web servers 120 with associated content storage units 125 (only two of which are shown), a search interface web server 130 with an associated content storage unit 135, and a search engine web server 140 with an associated content storage unit 145. The client computers 110, the web server computers 120, the search interface web server 130, and the search engine web server 140 are connected over a computer network 150, e.g., the Internet.

As illustrated in FIG. 1B, each client computer 110 includes conventional components of a computing device. They include a processor 111, system memory 112 and a hard disk drive 113, that communicate over a bus 114 and are contained within a housing 115, and external devices such as input devices 116, e.g., a mouse and a keyboard, and output devices 117, e.g., a monitor and a printer. Each web server (which may be any of the web servers 120, the search interface web server 130, and the search engine web server 140) includes a processor 121 and a system memory 122, and manages the contents stored in its respective content storage unit using software, e.g., a relational database software. The web server is programmed to communicate with the client computers 110 and other web servers using the TCP/IP protocol. The client computers 110 are programmed to execute web browser programs and access the web pages managed by the web servers by specifying a uniform resource locator (URL) for the web server into the browser.

In the embodiments of the present invention described below, users are respectively operating the client computers 110 that are connected to the search interface web server 130 over the Internet. The web pages that are displayed to a user are transmitted from the search interface web server 130 to that user's client computer 110 and processed by the web browser program stored in that user's client computer 110 for display through the monitor of that user's client computer 110.

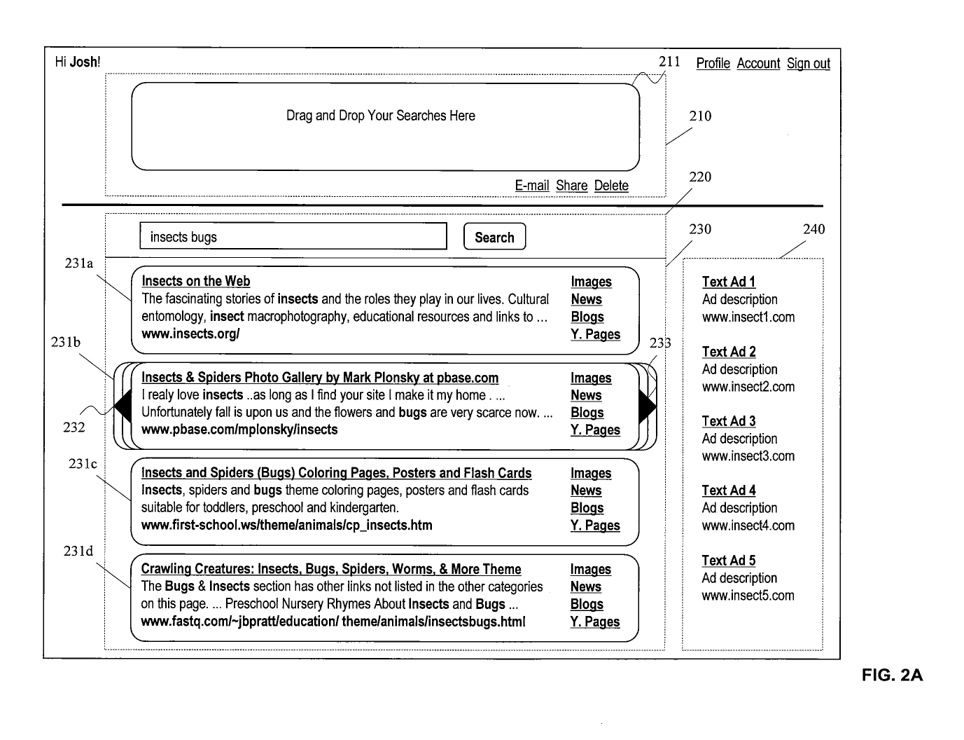

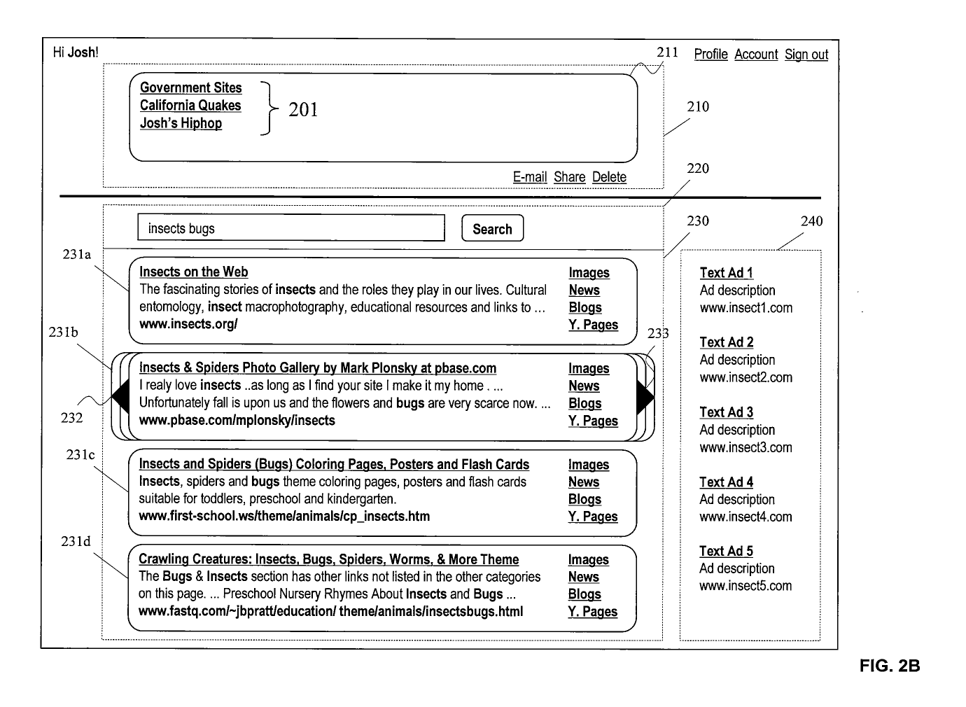

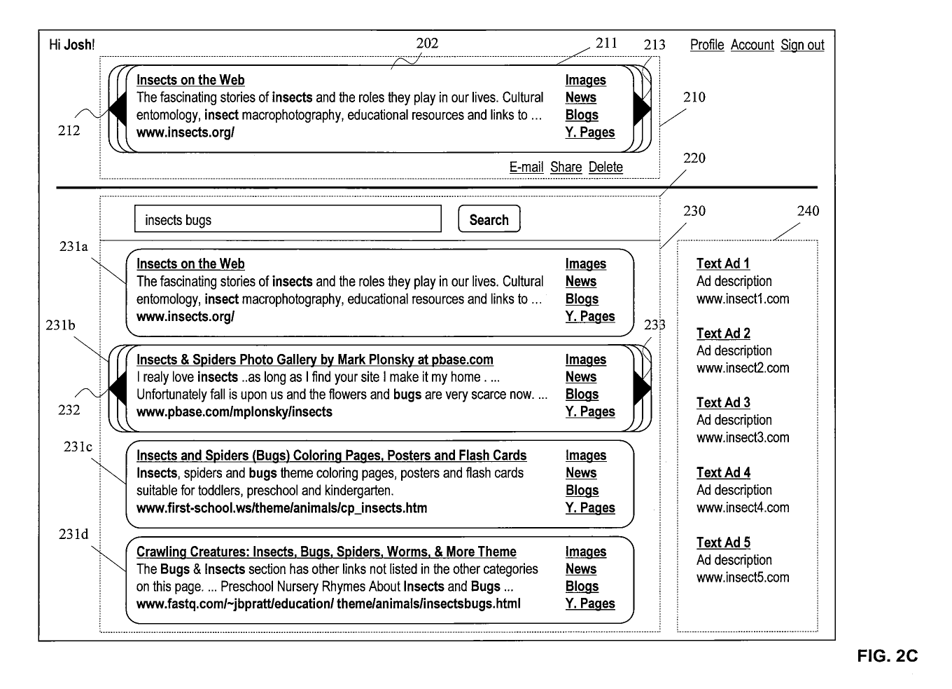

FIGS. 2A-C are schematic representations of web pages that include a GUI according to an embodiment of the present invention. These web pages are generated by the search interface web server 130 and transmitted to a user for display. FIG. 2A is a schematic representation of a web page that is generated by the search interface web server 130 and transmitted to the user for display when the user request an Internet search on the search query “insects bugs.” FIG. 2B is similar to FIG. 2A except a list of titles 201 are displayed on the upper part of the web page. FIG. 2C is similar to FIG. 2A and FIG. 2B except a page from a search listing collection 202 is displayed on the upper part of the web page.

The GUI of the web pages schematically represented in FIGS. 2A-2C has four different sections. The first section 210 is a section for collecting search results into user-defined groups, referred to herein as “search listing collections” or “notebooks” and managing the notebooks. The second section 220 is a section for inputting a search query. The third section 230 is a section for displaying search results that are responsive to the search query. The fourth section 240 is a section for displaying text advertisements that are responsive to the search query.

Each of the four sections comprises at least one inline frame (also known as iframe). The first section 210 comprises one inline frame. The second section 220 comprises one inline frame. The third section 230 comprises multiple inline frames. Each search result (231a, 231b, 231c, 231d) in the third section 230 is displayed in a separate inline frame. Some search results like the search result 231b have multiple pages. For these, the search result 231b is displayed one page at a time. Other pages of the search result 231b can be accessed by clicking on the left arrow 232 to turn pages back and on the right arrow 233 to turn pages forward. The fourth section 240 comprises one inline frame.

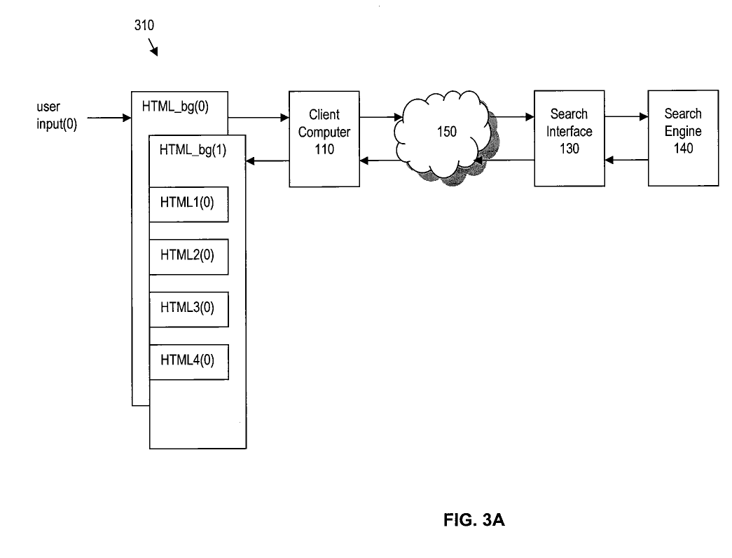

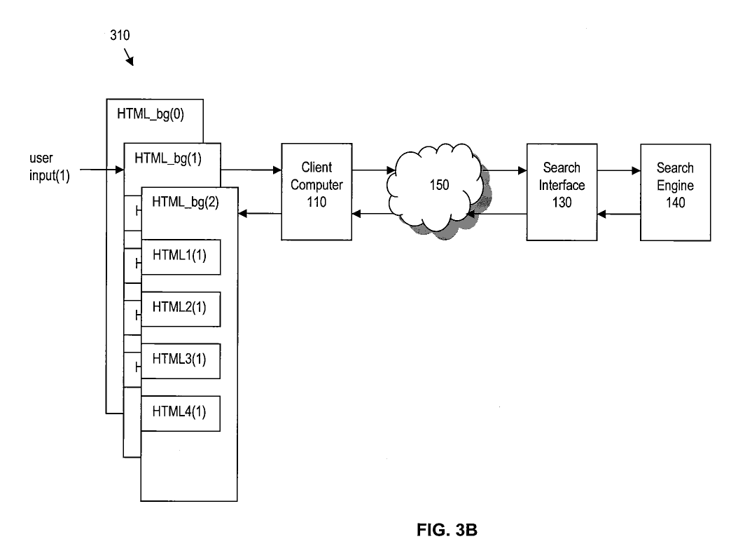

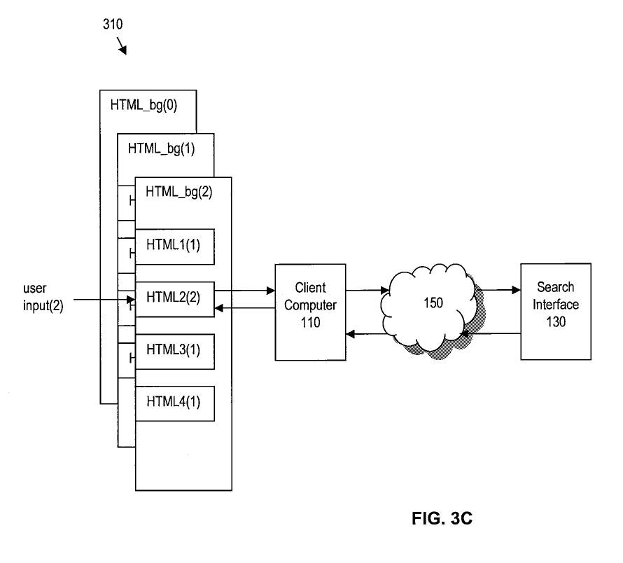

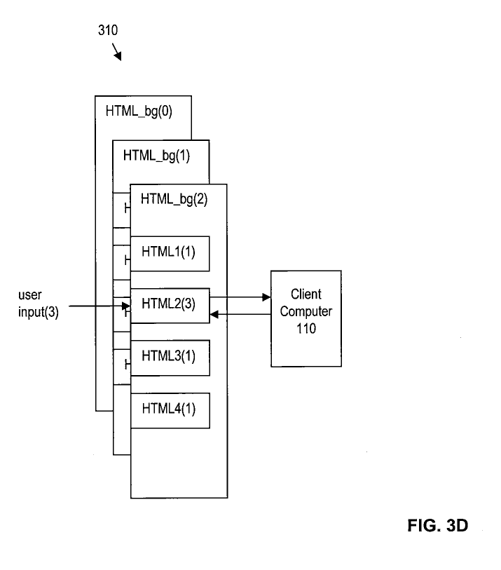

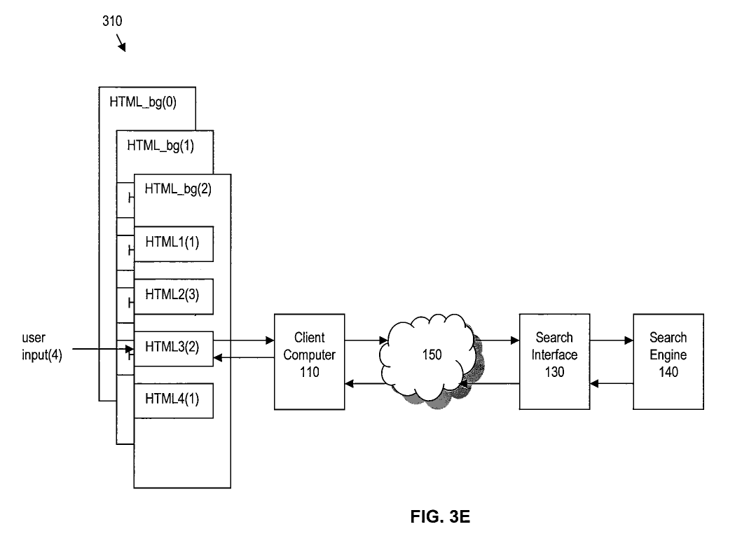

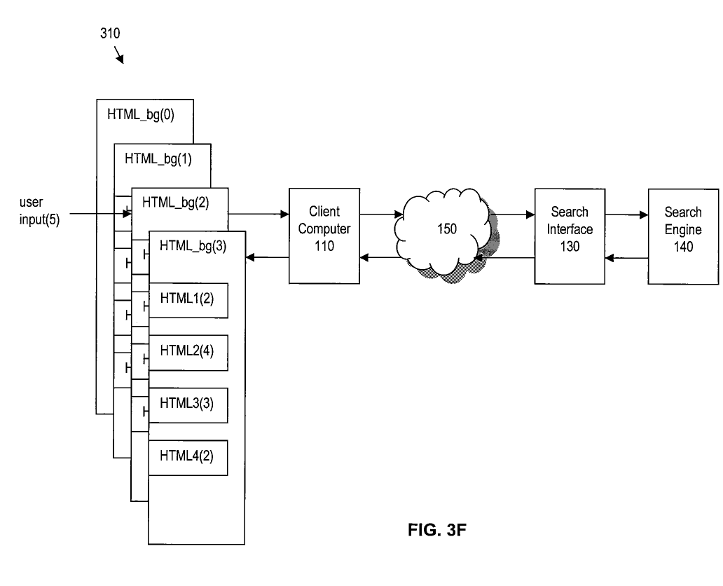

A GUI having inline frames permits any one of the inline frame to be updated with new content without disrupting the rest of the GUI. For example, a click on any of the following hyperlinks: Images, News, Blogs, and Y. Pages, within an inline frame of one of the search results 231, which is interpreted as a request to search the Internet for images, news, blogs, or yellow pages, respectively, based on search query and the content of the search result currently displayed in the inline frame, causes only the inline frame to update without disrupting the rest of the GUI. Also, when the user clicks on the GUI controls 232, 233 appearing in the inline frame corresponding to search result 231b, the display contents of this inline frame are updated without disrupting the rest of the GUI. The processes for updating one inline frame without affecting the rest of the GUI is further described in conjunction with FIGS. 3A-F.

In the processes illustrated in FIGS. 3A-3F, the display contents for GUI 310, exclusive of the search results, are represented as HTML_bg, and the display contents of each of the search results provided in an inline frame are represented as HTMLn. The number inside the parenthesis increments each time the display contents update. For example, HTML_bg(0) or HTMLn(0) indicates the initial display contents, and HTML_bg(1) indicates that the display contents, HTML_bg, have been updated once from HTML_bg(0), and HTMLn(1) indicates that the display contents, HTMLn, have been updated once from HTMLn(0). The user input is represented in FIGS. 3A-F as user_input. The number inside the parenthesis increments each time a new user input is made.

FIG. 3A illustrates a GUI 310 at two different points in time. Initially, the GUI 310 has no search results displayed. Then, the user submits a search request, represented as user_input(0), through the GUI 310. The client computer 110 passes on this search request to the search interface web server 130 over the Internet 150. The search interface web server 130 passes on this search request to the search engine web server 140 and receives search results in response thereto. The search interface web server 130 prepares a web page document with a plurality of inline frames for the search results and transmits it to the client computer 110 over the Internet 150. Upon receiving this information, the client computer 110 then generates the GUI 310 with the display contents, HTML_bg(1), and the search results displayed in separate inline frames, which are represented in FIG. 3A as HTML1(0), HTML2(0), HTML3(0), and HTML4(0).

FIG. 3B illustrates the GUI 310 at a third point in time, namely after the user submits another search request, represented as user_input(1), using the GUI 310. The client computer 110 passes on this search request to the search interface web server 130 over the Internet 150. The search interface web server 130 passes on this search request to the search engine web server 140 and receives search results in response thereto. The search interface web server 130 prepares a web page document with a plurality of inline frames for the search results and transmits it to the client computer 110 over the Internet 150. Upon receiving this information, the client computer 110 then generates the GUI 310 with the display contents, HTML_bg(2), and the search results displayed in separate inline frames, which are represented in FIG. 3B as HTML1(1), HTML2(1), HTML3(1), and HTML4(1).

FIG. 3C illustrates the GUI 310 at another point in time, namely after the user makes an input, represented as user_input(2), within the inline frame, HTML2. The input may correspond to a selection of one of the hyperlinks, Images, News, Blogs, and Y. Pages, within an inline frame for a search result (see FIG. 2A). If the inline frame displays a search listing collection, the input may also correspond to a click on the GUI controls for paging backward or forward. In either case, when the input is made, the client computer 110 processes the input and updates the display of just the inline frame, HTML2. The other inline frames and the rest of the GUI 310 are not updated. The process shown in FIG. 3C represents a case where the data for updating the inline frame, HTML2, is not stored in the client computer 110 and needs to be retrieved from the search interface web server 130.

The process shown in FIG. 3D represents a case where the data for updating an inline frame is already stored in the client computer 110. As shown in FIG. 3D, another user input, represented as user input(3), is made within the inline frame, HTML2. When the input is made, the client computer 110 recognizes that the requested information is already stored in the client computer 110 and updates the display of the inline frame, HTML2, with the requested information, without passing on this input to the search interface web server 130 over the Internet 150. As before, the other inline frames and the rest of the GUI 310 are not updated.

The process shown in FIG. 3E represents a case where the data for updating an inline frame is not stored in either the client computer 110 or the search interface web server 130. This may happen, for example, when a user requests a related search within an inline frame (e.g., by clicking on Images, News, Blogs, or Y. Pages hyperlink within an inline frame of one of the search results) and a further search needs to be executed in response to the request. As shown in FIG. 3E, the user makes an input, represented as user_input(4), within the inline frame, HTML3, and the client computer 110 passes on this input to the search interface web server 130 over the Internet 150. The search interface web server 130 passes on this search request to the search engine web server 140 and receives new search results in response thereto. The search interface web server 130 then transmits the new display contents for HTML3 based on the new search results to the client computer 110. The client computer 110 updates the display of the inline frame, HTML3, using the new display contents received from the search interface web server 130 without disrupting the display contents of the rest of the GUI 310

FIG. 3F illustrates the GUI 310 at another point in time, namely after the user submits another search request, represented as user_input(5), using the GUI 310. The client computer 110 passes on this search request to the search interface web server 130 over the Internet 150. The search interface web server 130 passes on this search request to the search engine web server 140 and receives search results in response thereto. The search interface web server 130 prepares a web page document with a plurality of inline frames for the search results and transmits it to the client computer 110 over the Internet 150. Upon receiving this information, the client computer 110 then generates the GUI 310 with the display contents, HTML_bg(3), and the search results displayed in separate inline frames, which are represented in FIG. 3F as HTML1(2), HTML2(4), HTML3(3), and HTML4(2).

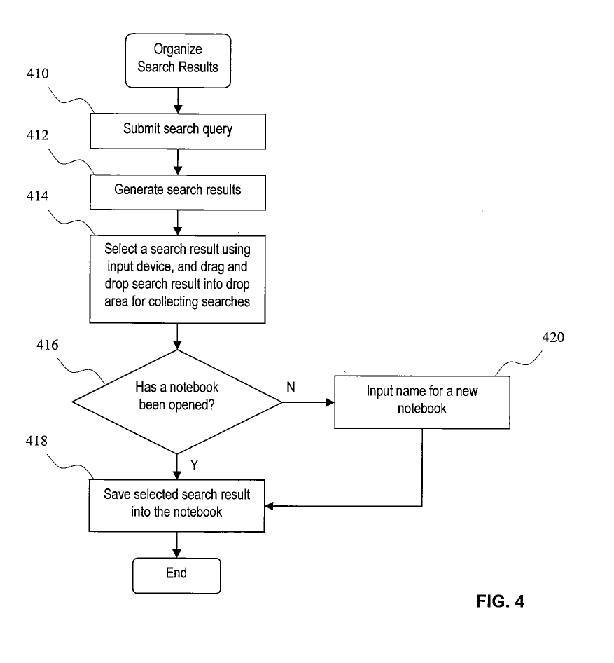

According to embodiments of the present invention, search results can be organized into search listing collections or notebooks. This process is illustrated in FIG. 4 and will be described with reference to FIGS. 2A-2C. In step 410, the user inputs a search query into the second section 220 and clicks on the “Search” button. In response, search results 231 are generated in the third section 230 for review by the user (step 412). In step 414, the user selects one of the search results using an input device (e.g., by positioning the mouse cursor on top of a search result and clicking on the mouse button), drags the selected item on top of a drop region 211 provided within the first section 210 (e.g., by moving the mouse cursor within the drop region 211 while keeping the mouse button pressed), and drops the selected item into the drop region 211 (e.g., by releasing the mouse button when the mouse cursor is within the drop region 211). When a notebook is already opened in the first section 210 (step 416), the search result dropped into the drop region 211 is added as one of the pages in the opened notebook (step 418). However, if the first section 210 does not have a notebook already opened (step 416), the user is prompted to input a name for a new notebook (step 420), and the search result dropped into the drop region 211 is saved as the first page of the new notebook (step 418).

If the first section 210 does not have a notebook already opened, the drop region 211 displays a list of notebooks as shown in FIG. 2B. When a notebook is already opened in the first section 210, the drop region 211 displays one page 202 from the notebook as shown in FIG. 2C. Other pages of the notebook may be accessed by clicking on the left arrow 212 to turn pages back and on the right arrow 213 to turn pages forward.

A notebook created in the manner described above may be shared with other users. One way to do this is to e-mail a notebook to another user using the E-mail hyperlink. Another way is to specify viewing and editing privileges for the other users using the Share hyperlink. The third hyperlink shown in the first section 210 is Delete. This hyperlink allows the user to delete a page from the notebook currently displayed in the drop region 211 or delete a notebook in its entirety by selecting the notebook to delete from the list displayed in the drop region 211 (e.g., the list 201 shown in FIG. 2B).

When a user makes a selection from a notebook, the user may select a single page from the notebook (e.g., by clicking on the displayed page) or the entire notebook (e.g., by clicking on the multi-page graphic behind the displayed page). When the entire notebook is selected and subsequently dragged and dropped into the drop region 211, a new notebook is created for the user if the user does not have editing privileges to the selected notebook. On the other hand, if the user has editing privileges to the selected notebook, the notebook will be treated as one of the notebooks of the user and all edits made by anyone who has editing access to this notebook will be reflected globally.

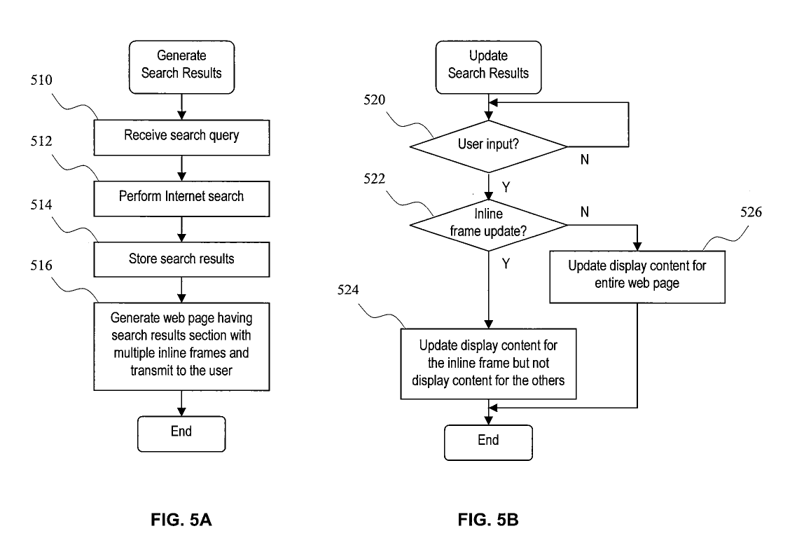

FIG. 5A is a flow diagram that illustrates the steps carried out by the search interface web server 130 to generate a web page including search results according to an embodiment of the present invention. In step 510, the search interface web server 130 receives a search query from a client computer 110 over the Internet 150. Then, in step 520, the search interface web server 130 performs the requested search through the search engine web server 140. The search engine web server 140 generates the search results and transmits them to the search interface web server 130 for storage (step 530). The search interface web server 130 then generates a web page with multiple inline frames, each of which encapsulates either a single search result or multiple search results within a notebook (step 516), and transmits the web page to the user.

FIG. 5B is a flow diagram that illustrates the steps carried out by the search interface web server 130 to update a web page including search results according to an embodiment of the present invention. In step 520, the search interface web server 130 awaits for a user input. If the user input is made within an inline frame and the update data provided in response thereto only affects the inline frame (step 522), the display contents for that inline frame are updated without disrupting the display contents for the other inline frames and other sections of the web page (step 524). Otherwise, the display contents for the entire web page are updated (step 526).

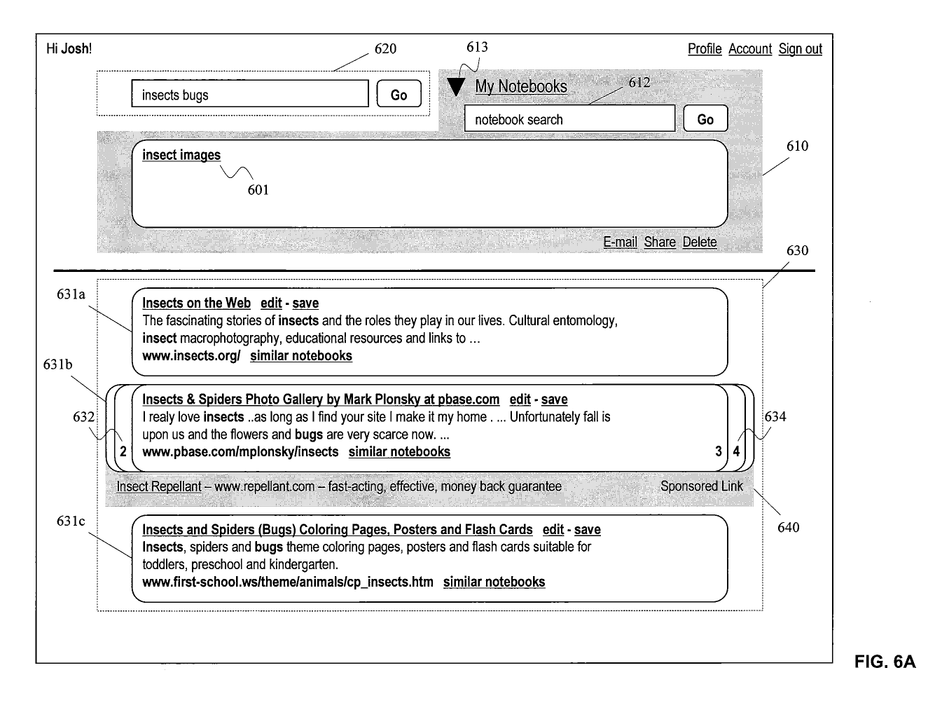

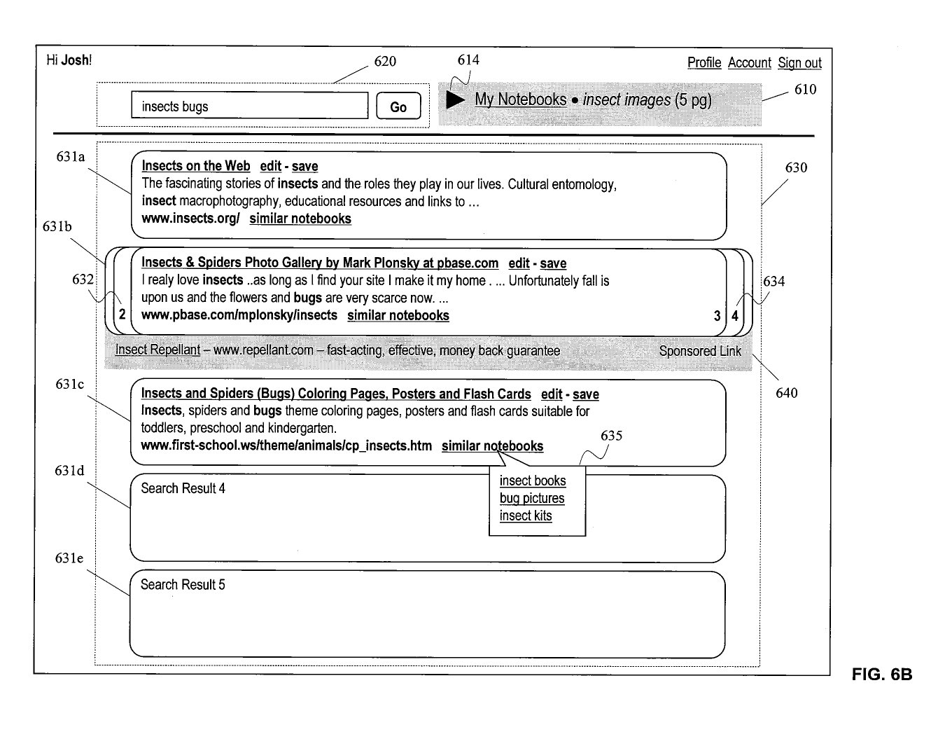

FIGS. 6A-B are schematic representations of web pages that include a GUI according to another embodiment of the present invention. These web pages are generated by the search interface web server 130 and transmitted to a user for display.

FIG. 6A is a schematic representation of a web page that is generated by the search interface web server 130 and transmitted to the user for display when the user request an Internet search on the search query “insects bugs.” FIG. 6B is the same as FIG. 6A except: (i) insect images notebook 601 is closed in FIG. 6A whereas it is open in FIG. 6B; and (ii) My Notebooks section 610 has been collapsed so that additional search results 631d, 631e can be displayed at the bottom part of the GUI.

The GUI of the web pages schematically represented in FIGS. 6A-6B has three different sections including a first section (My Notebooks section) 610, a second section 620, a third section 630, and a fourth section 640. The first section 610 operates in the same manner as the first section 210 of FIGS. 2A-2C, except that the first section 610 can be collapsed by clicking on the down arrow 613 and expanded by clicking on the right arrow 614. The drop region of the first section 610, identified with a darker background in FIGS. 6A-6B, is active in either the expanded state or the collapsed state, so that search results can be added to a notebook by selecting them, dragging them to this region and then dropping them in this region. The second section 620 is a section for inputting a search query. The third section 630 is a section for displaying search results 631 that are responsive to the search query, and text advertisements (e.g., sponsored link 640) that are responsive to the search query. In the embodiment of the GUI shown in FIG. 6A-6B, a text advertisement appears directly underneath each notebook, such as under search result 631b.

Each of the three sections 610, 620, 630 comprises at least one inline frame. The first section 610 comprises one inline frame. The second section 620 comprises one inline frame. The third section 630 comprises multiple inline frames. Each search result 631 in the third section 630 is displayed in a separate inline frame, and each sponsored link 640 in the third section 630 is displayed in a separate inline frame. Some search results, such as search result 631b, may comprise notebooks. For these, the pages from the notebooks are displayed one at a time. Other pages of the notebooks can be accessed by clicking on GUI control for the previous page number (e.g., GUI control 632) or the next page number (e.g., GUI control 634). The page number of the current page is also displayed.

Each search result 631 provides an abstract of, and a hyperlink to, the web site with which it is associated, and several additional hyperlinks, including “edit,” “save,” and “similar notebooks.” The “edit” hyperlink allows the owner of the web site to edit the abstract of his or her web site. The edited abstract is stored by the search interface web server 130, so that the next time such web site is included in a search result, the edited abstract is displayed to the user. The “save” hyperlink allows the user to save a search result into a notebook. If the user clicks on the “save” hyperlink from the displayed page of a notebook, the user is prompted to choose between “save the entire notebook” and “save this page from the notebook.” If the user clicks on the “save” hyperlink from an individual search listing, the individual search listing is stored in the notebook that is currently open in the first section 610. If no notebook is currently open in the first section 610, the user is prompted for a name of a new notebook or an existing notebook into which the individual search listing will be added. The “similar notebooks” hyperlink of a search result causes to be displayed a pop-up menu 635 of notebooks that are most relevant to the search result, when a user clicks on or positions a cursor of a pointing device on top of this hyperlink. A selection of one of the notebooks causes that notebook to be displayed in the display section for the search result in place of the search result.

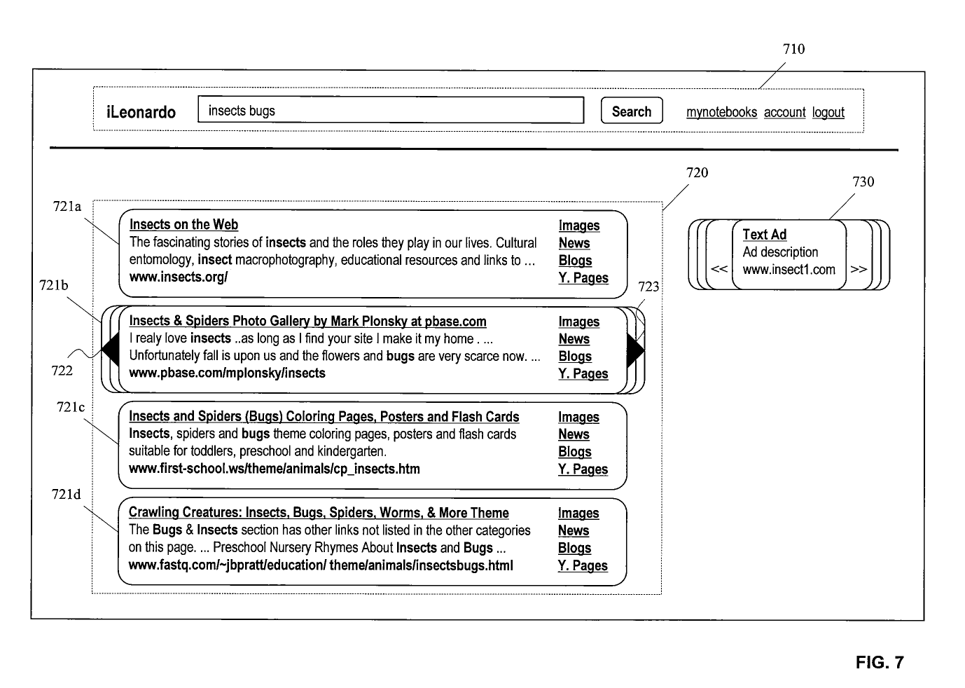

FIG. 7 is a schematic representation of a web page that includes a GUI according to still another embodiment of the present invention. This web page is generated by the search interface web server 130 and transmitted to a user for display when the user request an Internet search on the search query “insects bugs.” The GUI of the web page schematically represented in FIG. 7 has three different sections. The first section 710 is a section for inputting a search query, and includes a “mynotebooks” hyperlink that opens up a notebook section such as the first section 210 of FIGS. 2A-2C. The second section 720 is a section for displaying search results that are responsive to the search query. The third section 730 is a section for displaying sponsored links that are responsive to the search query.

Each of the three sections comprises at least one inline frame (also known as iframe). The first section 710 comprises one inline frame. The second section 720 comprises multiple inline frames. Each search result (721a, 721b, 721c, 721d) in the second section 720 is displayed in a separate inline frame. Some search results like the search result 721b have multiple pages. For these, the search result 721b is displayed one page at a time. Other pages of the search result 721b can be accessed by clicking on the left arrow 722 to turn pages back and on the right arrow 723 to turn pages forward. The third section 730 comprises one inline frame that displays a collection of sponsored links one at a time. Other sponsored links can be displayed in this section by clicking on “>>” to page forward and “<<” to page backward.

As described above, a GUI having inline frames permits any one of the inline frame to be updated with new content without disrupting the rest of the GUI. As a result, when the user clicks on the GUI controls 722, 723 appearing in the inline frame corresponding to search result 721b, the display contents of this inline frame are updated without disrupting the rest of the GUI, i.e., without causing the display contents of the rest of the GUI to also update. In the same manner, when the user clicks on the GUI controls “<<” and “>>” appearing in the inline frame for the third section 730, the display contents of this inline frame are updated without disrupting the rest of the GUI, i.e., without causing the display contents of the rest of the GUI to also update.

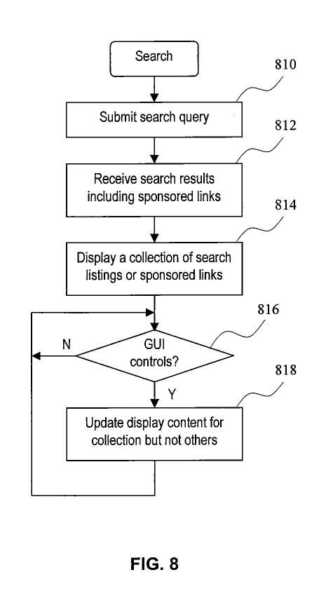

FIG. 8 is a flow diagram that illustrates the steps carried out by a client computer in response to a user who is making inputs to a GUI that displays a search listing collection or a sponsored link collection. The illustrated process begins with a user entering a search query and clicking on the “Search” button. In response, the client computer in step 810 submits the search query to the search interface server computer 130. Then, the search interface server computer 130 generates search results that are responsive to the submitted search query, including sponsored links, and returns them to the client computer. The search results that are responsive to the submitted search query, including sponsored links, are received by the client computer in step 812. A search result may be a collection of search listings or a collection of sponsored links. In such a case, the search listing or sponsored listing from the collection is displayed to the user one at a time with a graphic representing the collection and GUI controls for moving or scrolling forward and backward through the collection (step 814). The client computer monitors whether any of the GUI controls are selected in step 816. If it is, the display content for the collection is updated (step 818). For example, if the forward GUI control is selected, the next search listing or sponsored link in the collection is displayed without updating the display content for the other parts of the GUI. If the backward GUI control is selected, the previous search listing or sponsored link in the collection is displayed without updating the display content for the other parts of the GUI. To allow for immediate access to the new content in the collection to be displayed, it is preferable to have the content for all the search listings or sponsored links in a collection be generated and transmitted by the search interface server computer 130, received by the client computer, and stored locally in a system memory of the local computer.

The functionalities of the GUIs described above may be implemented in the web pages using a markup language, scripting languages and associated libraries that provide inline framing, drag and drop, and other dynamic visual effects and user interface elements provided by the Prototype JavaScript Framework via the Document Object Model. The library that is employed in the embodiments described above is known as “scriptaculous.”

While particular embodiments according to the invention have been illustrated and described above, those skilled in the art understand that the invention can take a variety of forms and embodiments within the scope of the appended claims.

What is claimed is:

1. A graphical user interface (GUI) generated by a client computing device in communication with a server computing device over a communications network, the GUI comprising:
a first section including a text input field for a search query; and
a second section comprising a plurality of subsections, each subsection displaying at least one search result that is responsive to the search query,
wherein the displayed content of each one of the subsections can be updated independently with respect to the first section and other subsections, in response to data received from the server computing device.

2. The GUI according to claim 1, further comprising a third section using which the search results can be organized into groups.

3. The GUI according to claim 2, wherein the third section includes a drop region, and a search result displayed in any of the subsections can be organized into a group by selecting the search result and then dragging and dropping the search result into the drop region of the third section.

4. The GUI according to claim 3, wherein the third section displays a list of hyperlinks, each associated with a search result group.

5. The GUI according to claim 1, wherein a subsection in the second section displays a group of search listings one at a time and includes GUI controls for moving between the search listings of the group.

6. The GUI according to claim 1, wherein each of the subsections comprises an inline frame.

7. A graphical user interface (GUI) generated by a client computing device in communication with a server computing device over a communications network, the GUI comprising:
a first section including a text input field for a search query; and
a second section comprising search results, wherein one of the search results includes multiple pages that are displayed one page at a time and GUI controls for moving to different pages of the search result,
wherein the displayed page of said one of the search results can be changed without updating the other search results in the second section.

8. The GUI according to claim 7, wherein said one of the search results comprises a collection of search listings, wherein each of the multiple pages corresponds to one of the search listings.

9. The GUI according to claim 7, wherein said one of the search results comprises a collection of sponsored links, wherein each of the multiple pages corresponds to one of the sponsored links.

10. The GUI according to claim 7, wherein said one of the search results is displayed within an inline frame.

11. A method for organizing search results using a graphical user interface (GUI), comprising the steps of:
inputting a search query into the GUI;
reviewing a plurality of search results generated in response to the search query and displayed on the GUI;
selecting at least one of the search results using a pointing device and dragging the selected item into a drop region defined in the GUI; and
inputting a name for the group of search results dragged and dropped into the drop region and saving the group of search results under the name.

12. The method according to claim 11, wherein one of the search results is a group search result that has been saved by another user.

13. The method according to claim 12, further comprising the step of selecting the group search result using the pointing device and dragging the selected item into the drop region.

14. The method according to claim 13, wherein the group search result includes multiple pages that are displayed one at a time and the step of reviewing includes the step of selecting control hyperlinks to move between the multiple pages.

15. The method according to claim 14, wherein a selection of one of the control buttons updates the display of the group search result but not the displays of other search results.

16. A method for generating a web page containing search results, comprising the steps of:
receiving a search query;
storing search results that are responsive to the search query; and
generating a web page containing the search results, the web page comprising a first section defining an input section for a search query, and a second section containing the search results,
wherein the second section defines a plurality of inline frames, each containing at least one search result.

17. The method according to claim 16, further comprising the step of generating the search results that are responsive to the search query prior to the step of storing.

18. The method according to claim 16, further comprising the steps of issuing the search query to a third party and receiving the search results from the third party after the search results have been generated by the third party.

19. The method according to claim 16, wherein the web page further comprises a third section using which the search results can be organized into groups and a fourth section for advertisements that are relevant to the search results.

20. The method according to claim 16, further comprising the steps of:
receiving a user input through one of the inline frames; and
in response to said user input, generating updated content for said one of the inline frames and not for said other inline frames.
